(19) United States
(12) Patent Application Publication
(10) Pub. No.: US 2021/0402322 A1
(43) Pub. Date: Dec. 30, 2021

(54) APPARATUS AND METHOD FOR CRYSTALLISATION

(71) Applicants: MEDAD TECHNOLOGIES PTE LTD, Singapore (SG); KING ABDULAZIZ CITY FOR SCIENCE AND TECHNOLOGY, Riyadh (SA)

(72) Inventors: Ang Li, Singapore (SG); Joseph Su Hui Ng, Singapore (SG)

(21) Appl. No.: 16/479,755

(22) PCT Filed: May 17, 2017
(86) PCT No.: PCT/SG2017/050256

§ 371 Date: Jul. 22, 2019

(30) Foreign Application Priority Data
Jan. 23, 2017 (SG) 10201700545S

(51) Int. Cl. B01D 9/00; B01D 5/00; B01D 53/26; B01D 53/04; C02F 1/04; B01D 3/10; C02F 1/06

(52) U.S. Cl. CPC B01D 9/0022; B01D 9/0059; B01D 9/0063; B01D 5/006; B01D 53/261; B01D 53/265; C02F 2001/5218; C02F 1/048; B01D 3/10; C02F 1/06; B01D 2009/0086; B01D 2257/80; B01D 2259/40092; B01D 53/0438

(57) ABSTRACT

The present invention relates to the distillation and crystallization of feed water. In particular, the present invention relates to the distillation and crystallization of industrial wastewater or saline or brackish water. The present invention relates to both an apparatus and method for carrying out the distillation. In an aspect of the present invention, there is provided a distillation apparatus comprising: (a) an crystalliser for evaporating a feed water to produce water vapour; (b) adsorption means in vapour communication with the crystalliser for reversibly adsorbing the water vapour from the crystalliser; and (c) desorbing means for desorbing the adsorbed water vapour from the adsorption means, wherein the crystalliser evaporates the feed water under pressure that is substantially lower than atmospheric pressure to form a concentrated solution or slurry comprising crystallised solids.

### FIELD OF THE INVENTION

The present invention relates to the distillation and crystallisation of feed water. In particular, the present invention relates to the distillation and crystallisation of feed water, e.g. industrial wastewater or saline or brackish water.

### BACKGROUND OF THE INVENTION

It is known in the art of treating contaminated solvents such as effluent water, using a variety of systems and methods like membrane filtration and distillation. However, conventional solvent treatment systems generally lack the ability to process a broad range of effluent produced from common industrial practices. For example, membranes made from organic polymers or compounds are susceptible to corrosion, therefore limiting their ability to process tailings from oil, gas or mining operations or chemical waste products. Systems for distilling water such as the multi-stage flash (MSF) type and the multi-effect desalination type are well known to encounter scaling and maintenance issues, and moreover require a large amount of additional energy to bring the solvent to a vapour phase. What is more, both methods hitherto are limited in treating contaminated solvents up to 10 to 20%, and crystalliser is one of the few options to further treat the more concentrated solvents and achieve a complete separation of the solvents and contaminates.

Conventional crystallizers, however, suffers from significantly high costs. Numerous amount of payable energy in the form of steam and electricity is consumed in crystallization processes.

Vacuum or high pressure systems must be designed to safely contain the processes and require additional boiler or turbo-machinery, which considerably increases capital expenditures. Moreover, systems that incorporate crystallisers typically use high-cost titanium to prevent corrosion in the high-pressure, high-temperature environments employed. Therefore, there is a need for an improved distillation and crystallisation system.

The listing or discussion of an apparently prior-published document in this specification should not necessarily be taken as an acknowledgement that the document is part of the state of the art or is common general knowledge.

Any document referred to herein is hereby incorporated by reference in its entirety.

### SUMMARY OF THE INVENTION

It is therefore an object of the present invention to provide for a distillation and crystallization apparatus and method that is energy efficient, cost effective and environmentally benign.

In a first aspect of the present invention, there is provided a crystallisation apparatus comprising: (a) an crystalliser for evaporating a feed water to produce water vapour; (b) adsorption means in vapour communication with the crystalliser for reversibly adsorbing the water vapour from the crystalliser; and (c) desorbing means for desorbing the adsorbed water vapour from the adsorption means, wherein the crystalliser evaporates the feed water under pressure that is substantially lower than atmospheric pressure to form a concentrated solution or slurry comprising crystallised solids.

Preferably, the crystalliser evaporates the feed water at a temperature between 0 to 70° C. More preferably, the crystalliser evaporates the feed water at a temperature below 40° C.

Preferably, the crystallisation in the crystalliser is carried out at a pressure of between 0.6 kPa to 32 kPa.

Preferably, the apparatus further comprises a boiler for heating the feed water prior to the feed water entering the crystalliser, the heat in the feed water aids the evaporation of the water vapour. Preferably, the boiler comprises hot water with a temperature of 5° C. to 85° C. In an embodiment, the boiler is a brine heat exchanger. A brine heat exchanger is typically a common shell and tube heat exchanger, or a plane heat exchanger with two flow streams. The hot stream is from any heat sources, and the cool stream is the brine to be heated up.

Preferably, the apparatus further comprises a vacuum pump in vapour communication with the crystalliser for creating a low vacuum state in the crystalliser.

By “crystalliser”, it is meant to include any apparatus or part of an apparatus that allows for the vapourisation of the feed water or any fluid. It may or not may include any boiler for increasing the temperature of the feed water to achieve evaporation. In an embodiment of the present invention, the crystalliser may be an ultra-low temperature crystalliser. In such a crystalliser, the feed water evaporates and leaves behind a slurry comprising crystallised solids, e.g. salts.

By “adsorption means” and “desorbing means”, it is meant to include the use of adsorbent materials that employ sorption principles.

Preferably, the adsorption means comprises a plurality of adsorption beds configured to perform adsorption and desorption in a sequential manner to achieve a continuous operation. Each bed may comprise a finned-tube heat exchanger and an adsorbent material selected from the group comprising: silica gel, synthetic zeolite, silicalite, activated carbon, metal organic frameworks and synthetic alumina.

Preferably, the adsorption means comprises a cooling means to provide cooling to aid in the adsorption of the water vapour.

Preferably, the desorbing means comprises a heating means to provide heating to aid in the desorption of the adsorbed water vapour.

Preferably, the apparatus further comprises a condenser in vapour communication with the adsorption means. The condenser may comprise a condenser tube in fluid communication with the boiler, and the condenser tube is configured to allow heat in the desorbed vapour to be taken up by water in the condenser tube and circulate the heat to the boiler.

Preferably, the device further comprises at least a first valve between the at least one vaporisation chamber and adsorption means. Preferably, the device further comprises at least a second valve to control a flow of the desorbed water vapour.

In a second aspect of the present invention, there is provided a method for crystallising a feed water, the method comprising: (a) crystallising the feed water under pressure that is substantially lower than atmospheric pressure to form a concentrated solution or slurry comprising crystallised solids, in a crystalliser to produce water vapour; (b) reversibly adsorbing the water vapour from the crystalliser using an adsorption means in vapour communication with the crystalliser; and (c) desorbing the adsorbed water vapour from the adsorption means using a desorbing means.

Preferably, the method comprises crystallising the feed water in the crystalliser at a temperature between 0 to 70° C. More preferably, the method comprises evaporating the feed water in the crystalliser at a temperature below 40° C.

Preferably, the method comprises crystallising the feed water in the crystalliser at a pressure of between 0.6 kPa to 32 kPa.

Preferably, the feed water is heated prior to evaporating the feed water in the crystalliser, the heated feed water aids in the evaporation of the water vapour. In an embodiment, the heating is carried out by a boiler comprising hot water at a temperature between 5 to 85° C.

Preferably, the method further comprises evaporating the feed water in a state of low vacuum.

Preferably, the evaporating and adsorbing steps are performed until a substantial quantity of vapour is adsorbed or saturation of the adsorption means, disengaging the vapour communication between the crystalliser and the adsorption means when the adsorption means is saturated, and desorbing the adsorbed water vapour from the adsorption means until a substantial quantify of the adsorbed water vapour has been desorbed from the adsorption means, and re-establishing the vapour communication between the crystalliser and the adsorption means.

Preferably, the adsorption means comprises a plurality of adsorption beds configured to perform adsorption and desorption in a sequential manner to achieve a continuous operation.

Preferably, the method further comprises providing a cooling means to the adsorption means to aid in the adsorption of the water vapour.

Preferably, the method further comprises providing a heating means to the desorbing means to aid in the desorption of the adsorbed water vapour.

Preferably, desorbing the adsorbed water vapour from the adsorption means comprises circulating hot water proximate to the array of beds, the hot water is at a temperature between 60° C. to 85° C.

Preferably, the method further comprises delivering the water vapour to a condenser for condensing the water vapour. In an alternative embodiment, a condenser is not required. Instead, vapour from the desorption beds directly condenses in the hot stream of the brine heat exchanger, and heat up the feedwater for evaporation.

Preferably, the method further comprises the step of de-aerating the feed water prior to the heating and evaporating it.

Preferably, the feed water for the above aspects of the invention is any water selected from the group comprising: brackish, sea, produce, reverse osmosis rejects, waste, and salt.

Advantageously, the present invention provides an energy efficient, cost effective and environment benign method and apparatus to achieve zero liquid discharge (ZLD) in distillation of feed water or, as the case may be, wastewater treatment.

Environmental pollutions caused by wastewater discharge in many industries have drawn governments' attentions. Practical effects are being made through stricter regulations to require zero liquid discharge on wastewater treatment. Much less waste is needed to be disposed as solid.

Using the crystallisation system of the present invention, we have now provided an apparatus and method to carry out crystallization or precipitation of a feed water (e.g. wastewater) in a low temperature and pressure environment while, at the same time produce high grade distillate water. By using a crystallisation or precipitation operation to carry out or perform evaporation of the feed water, the final reject product of the process is in a solid form that is much easier to dispose given its form and volume. In addition, by carrying out the evaporation at ultra-low temperatures, the chemical usage are thus considerably reduced. This in turn results in the needs for wastewater pre-treatment and maintenance being significantly reduced.

Existing crystallizers use boilers and mechanical compressors as power component to the crystallization process. The steam generated from the boiler refers to high temperature (>100° C.) and high pressure steam (>atmospheric pressure, 101.3 kPa) as energy source. The mechanical compressor is eventually using electricity as energy source. Both the steam and electricity are payable energy and incur high cost. In this work, the presented invention use adsorption beds (AD) as a power component to drive crystallization. AD is able to harvest low grade waste heat as power input which can be industrial exhausts, or renewable energy such as solar thermal or geothermal. Such low grade heat is deemed non-payable.

Here, the sub-atmospheric (vacuum) pressure is created through the interaction between adsorbents and water vapour in the crystallizer chamber, leading to a low temperature environment for evaporation and crystallization of feed water. Since many salts reduce solubility in water at low temperature, evaporation and crystallization of feed water take place at a lower concentration and boiling point elevation than existing crystallizers.

Advantageously, the evaporation and crystallization at low temperatures and concentrations also reduces solution corrosivity in the system, and hence reduces the need for expensive materials such as noble alloy. In addition, the present crystallizer apparatus consumes very little electricity only in water pumps and control panels. It saves up 90% of electricity as compared to existing mechanical vapour compressor crystallizer.

Compared to conventional crystallizers that use high grade thermal energy (boilers) or electricity (mechanical vapour compressors) to generate crystallizations, which are payable, the present invention utilizes non-payable low grade heat of typically 60 to 85° C. Such low temperature is available in abundance from exhausts of industrial processes like power plants and refineries (as waste heat), or renewable energy sources such as solar and geothermal. Ultra-low temperature crystallization process largely reduces corrosion scaling and fouling potential in the crystallizer. Only de-aeration is needed in the pre-treatment process. Also, the present apparatus has no major moving parts. As such, the present apparatus and method is robust and maintenance cost is low. Due to chemically stable adsorbent material and no wear-and-tear from major moving parts, the apparatus will have a long lifespan.

Given the above, the present invention advantageously provides for a green solution as it is able to harvest low grade heat from exhaust of power plants and refineries, or renewable energy like solar and geothermal to power the evaporation system. No or minimal carbon dioxide is emitted during operation of the apparatus and method, and the apparatus delivers the same advantages in salt production industries. In particular, because of use of deep vacuum environment to evaporate the feed water, the present invention produces high grade distillate since the evaporation processes can take place below ambient temperature to as low as 0° C. This means that cooling can also be extracted from the evaporation processes, e.g. this cooling may be used for air conditioning, etc. avoiding the use of ozone depleting refrigerants.

Further, since very the major components of the apparatus do not move during the operation process, the wear and tear of the apparatus is reduced. This leads to reduced maintenance costs and a long operating lifespan.

In order that the present invention may be fully understood and readily put into practical effect, there shall now be described by way of non-limitative examples only preferred embodiments of the present invention, the description being with reference to the accompanying illustrative figures.

### BRIEF DESCRIPTION OF THE FIGURES

In the Figures:

FIG. 1 is a schematic diagram showing the distillation apparatus and method according to an embodiment of the present invention; and

FIG. 2 is a schematic diagram showing the distillation apparatus and method according to another embodiment of the present invention; and

FIG. 3 is a schematic diagram showing the distillation apparatus and method according to another embodiment of the present invention.

### DETAILED DESCRIPTION OF THE PREFERRED EMBODIMENTS

The present invention relates to the adsorption/desorption (AD) cycle where vapour regenerated from a crystalliser is adsorbed by the adsorbent of the adsorber bed via hydrophilic properties of the adsorbent material.

In particular, the present invention relates to an ultra-low temperature adsorption crystallizer (ULTAC) system which also employs sorption principles with adsorbent materials (constructed in AD beds) to enable brine evaporation in deep vacuum and at very low temperatures (as low as 0° C.). With the utilization of waste heat (typically 60° C. to 85° C. hot water), the AD adsorb water vapor creating low pressures and temperatures, and then discharge it into a higher pressure and temperature environment. Thus it can be seen as a thermal vapour compressor.

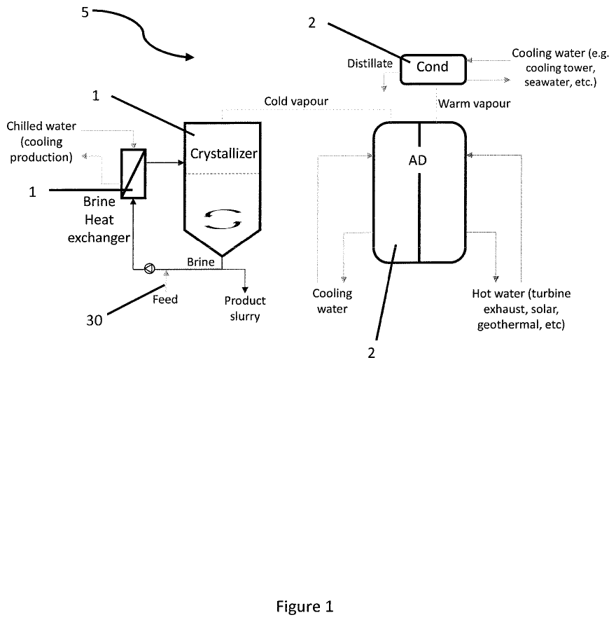

FIG. 1 shows a schematic diagram of the distillation apparatus 5 according to an embodiment of the present invention. In broad terms, the method as carried out by the apparatus 5 involves the evaporation of feed water to produce a water vapour. The water vapour is then adsorbed by adsorbent materials in adsorption beds. Once the adsorption beds are saturated or with a sufficient quantity of vapour, the water vapour is desorbed from the adsorption beds and the adsorption beds regenerated to receive water vapour. The water vapour may be condensed in a condenser and the distillate collected. The evaporation of water from the feed water thus forms a concentrated solution of the feed water or a slurry comprising of crystallised solids. As seen in FIG. 1, the apparatus 5 comprises of a crystalliser 10, a boiler 15, a condenser 20, and adsorption/desorption beds (beds) 25 in which adsorbent materials are located. The crystalliser 10 is in direct vapour communication with the adsorption/desorption beds 25 such that water vapour from the crystalliser 10 directly enters the adsorption/desorption beds 25.

In various embodiments, the crystalliser used for the present invention may be any type selected from the group comprising: a Draft Tube Baffle (DTB) type, an OSLO type, a Forced Circulation type, Evaporative type or Vacuum type. Typically, such crystallizers may include further structures such as an agitator, settling zone, etc. such that these structures aid in the formation of crystals.

In the present invention, the key function is to create a low temperature and low pressure environment for crystallization to take place. The crystals form in two ways. First, when the temperature and pressure of the solution reduce, the solubility of salt reduces. This cooling effect can help some salt cross the saturation point and crystalize. Second, water evaporates in the crystallizer, bring up the concentration of the solution to the crystallization point.

In a preferred embodiment of the present invention, the crystalliser 10 is in the form of a crystalliser 10 equipped with beds 25 that employs sorption principles with adsorbent materials working effectively as a thermal vapour compressor. The beds 25 are powered by low grade heat in the form of hot water (typically 60 to 85° C.), and enables evaporation and crystallisation to take place at ultra-low temperatures e.g. below 30° C., or at low temperatures e.g. between 30 to 70° C., with very little electricity consumption as the evaporation process is driven by the adsorption process. The recirculation of hot water to the beds 25 regenerate the adsorbent after each cycle such that the evaporation process is powered by the hot water. The hot water may be replaced by other liquids to reach a higher temperature, or is more conveniently available.

Feed water 30 is first supplied into the crystallizer and evaporates. By “feed water” 30, it is meant to include any brackish, sea, produce, reverse osmosis reject, and any other forms of wastewater in the industries, or salt solution in salt production industries.

The operating temperature (i.e. the temperature which the water in the solution evaporates) of the crystalliser 10 depends in part on the adsorption capacity of the beds 25, and the nature of the feed water 30 (i.e. solution content and concentration). It has been determined that the operating temperature varies from 0° C. to 70° C. at a pressure substantially lower than atmospheric pressure, in particular a pressure of 0.6 kPa to 32 kPa.

The triple point of water is known to be 0.01° C. and 612 Pa. However, the presence of solutes dissolved in the water depresses the melting point of water and elevates the boiling point of water. Hence, it is possible for the crystalliser to be used with feed water of different temperatures within the operating temperature range of the crystalliser. This allows the apparatus 5 and crystalliser 10 to be used in different seasons and climates.

In an embodiment, the operating temperature is below the ambient temperature where the apparatus 5 is sited. The operating temperature of the crystalliser could be any of the following ranges from 30° C. to 70° C. (a low temperature operation), from 0° C. to 30° C. (an ultra-low temperature operation).

In an embodiment, the feed water 30 is circulated through a boiler 15 to allow thermal exchange with a warmer heat source to provide additional energy to hasten the evaporation process. The same or different boilers could be used to heat the feed water 30, and the beds 25. In a preferred embodiment, the boiler 15 is a brine heat exchanger that heats the feed water 30 to a temperature above crystallization temperature, in particular up to a temperature of 70° C. A brine heat exchanger is usually a common shell and tube heat exchanger, or a plane heat exchanger with a hot and cold flow stream, the hot flow stream is from any heat source while the cold stream is the brine to be heated. The heated feed water 30 aids the evaporation of the water vapour.

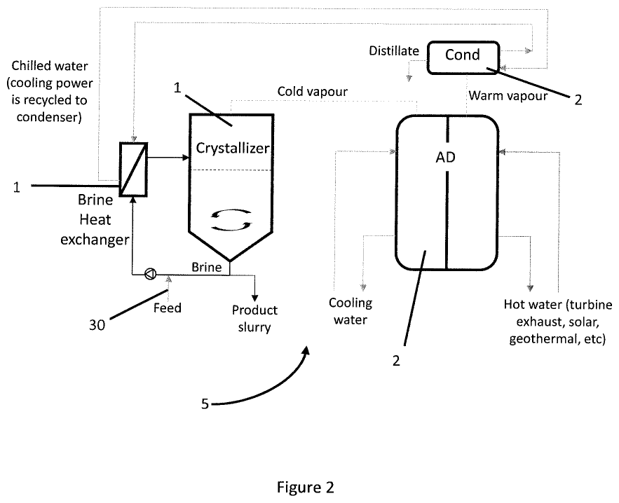

As shown in FIG. 2, the brine heat exchanger is in fluid communication with the condenser 20. The brine heat exchanger has a waste heat inlet for receiving condensate from the condenser, and a waste heat return outlet for returning water to the condenser 20. Alternatively, as shown in FIG. 1, the waste heat and waste return of the brine heat exchanger 15 may be in fluid communication with any other system external to the apparatus 5. A brine pump pumps the feed into the crystalliser.

The adsorption/desorption beds 25 are in vapour communication with the crystalliser 10. Inside the beds 25, adsorbent materials are constructed stationary on the fin-tube heat exchangers. Vapour from the crystalliser 10 enters the beds 25 and is adsorbed by the adsorbent material, e.g. silica gel, synthetic zeolite, silicalite, activated carbon, metal organic frameworks, synthetic alumina, or the like. Owing to the high affinity to water vapour, the adsorbent enables water to evaporate in the crystalliser 10 at temperatures as low as 0° C. This ultra-low operational temperature range will considerably reduce the scaling and fouling on the heat transfer surfaces. For the same reason, the need for pre-treatment filtration maintenance should also be reduced. Only minor de-aeration will be required in the pre-treatment process. Cooling water is used to reject heat generated during the adsorption process through the fin-tube heat exchangers.

Typically, an operating temperature of below 30° C. is considered an ultra-low temperature operation, while an operating temperature of between 30° C. to 70° C. is considered a low temperature operation.

When the adsorption/desorption beds 25 are saturated with water vapour, their vapour links with the crystalliser 10 are shut, and that with the condenser 20 are open. Entry and or exit valves to the beds 25 could serve to control the vapour communication between the beds 25, crystalliser 10 and condenser 20. A single valve could be used for a plurality of beds 25, or for each individual bed 25, this applies to both the entry and exit valve, and in combinations thereof.

Hot water of typically 60 to 85° C. is supplied to heat up the adsorbent materials in the adsorption/desorption beds 25 for regeneration through the same fin-tube heat exchangers. The adsorbent desorbs the water vapour to the condenser, High-quality pure distillate water is collected as the vapour condenses on the tube surfaces of the condenser. The adsorption/desorption beds are usually constructed in plurality of bed which performs adsorption and desorption in a sequential manner to achieve continuous operation. The crystalliser 10 has no major moving parts and requires only minimal maintenance for the pumps and valves. Heat rejection from the plant can be accomplished through cooling towers, radiators, seawater, etc.

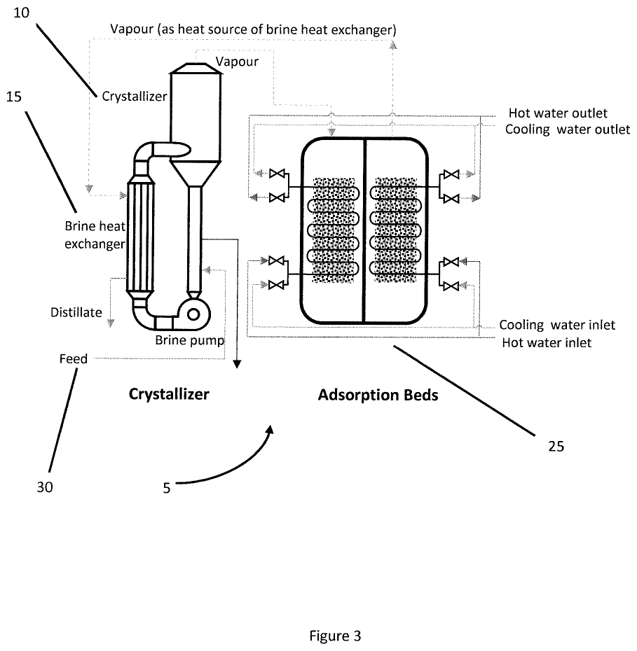

The apparatus 5 illustrated in FIG. 1 is a single-stage concept of the crystalliser 10. Since the evaporation temperature inside the crystalliser 10 is typically below ambient to as low as 0° C., cooling (entitled as “chilled water”) as a by-product can be extracted from the process. The chilled water can be utilised for air conditioning or other cooling purposes. FIG. 2 shows an alternative way of utilising the chilled water. It is recycled back to the condenser 20 to assist condensation, and at the same time reduces the cooling water requirement of the crystalliser 10. FIG. 3 shows an alternative embodiment of the present invention. The one main difference between this embodiment and the ones shown in FIGS. 1 and 2 is the absence of the condenser 20. In this embodiment, a condenser 20 is not required. Instead, vapour from the desorption beds directly condenses in the hot stream of the brine heat exchanger, and heat up the feedwater for evaporation.

FIG. 3 also shows in detail the flow of hot and cooling water through the AD beds 25—similar to the workings of the AD beds 25 shown in FIGS. 1 and 2. In particular, the AD bed 25 comprises two sets of hot/cooling water inlets and outlets on opposite sides of the AD bed 25. Here, vapour, as a heat source for the brine heat exchanger, travels directly to the brine heat exchanger.

The crystalliser 10 may additionally have an outlet to allow the discharge of the concentrated solution or slurry remaining in the crystalliser 10. The apparatus 5 may be run in batch or continuous mode.

Conventional crystallisers employ two methods of operation. The first method is to perform evaporation and crystallisation at a very high temperature. The vapour generated will be directly ventilated out to atmosphere naturally or assisted by fans or blowers. The second method is to use mechanical vapour compressors and powered by electricity. The vapour generated from evaporation enters a compressor, and is then compressed to higher temperatures and supplied back as heat source for evaporation. Also, conventional crystallisers use high grade thermal energy (boilers) or electricity (mechanical vapour compressors), and they perform evaporation and crystallisation at 50° C. and above. Conventional low temperature crystallizers may operate at lower temperatures using mechanical chillers or vapour compressors.

However, on the other hand, in the present invention, the water vapour from the crystalliser 10 enters the adsorption/desorption beds 25 directly. The beds 25 are powered by low grade heat of typically 60 to 85° C. to drive the adsorption process, and enables evaporation and crystallisation to take place at ultralow temperatures e.g. below 30° C., or low temperatures e.g. between 30 to 70° C., using very little electricity as it is driven by the adsorption process. The recirculation of hot water to the beds 25 regenerate the adsorbent after each cycle such that the evaporation process is powered by the hot water. This also provides significant benefits such as huge reduction in pre-treatment processes and maintenance costs.

As such, the key here is the implementation of AD beds 25 attached to the vapour outlet of the crystallizer 10, which draws vapour from the crystalliser into the AD beds 25. This allows for ultra-low temperature crystallisation and low grade heat driven, etc.

Advantageously, the apparatus 5 utilises low grade waste heat (power plant exhaust solar, geothermal, etc.), has zero or little carbon dioxide emission. The apparatus 5 and method has very low electricity consumption including only the water pumps, valves and control panel. It has no major moving parts, hence a low maintenance cost. Silica and the other alternative adsorbents are stable compounds with a lifespan up to 30 years. The method and apparatus are suitable for low or ultra-low temperature evaporation.

The present invention may be used to evaporate and produce clean water from feed water 30. The residue, in particular for industrial wastewater, will have significantly reduced water content (and volume) making it cheaper and easier to dispose of.

The present invention may be used to crystallise salts from an aqueous solution, whereby by simple filtration of the slurry formed in the crystalliser the crystallised salt can be obtained. The salt can be any salt purifiable by a crystallisation method including sodium chloride (table salt, or sea salt). This is applicable for use in the food and pharmaceutical industries.

Advantageously, the present invention can be regarded as a simple replacement of a Mechanical Vapour Compressor (MVC) in a conventional crystallizer by AD beds along with minimal modifications of the crystallizer chamber and the brine heat exchanger. The vapour compression of the AD beds may be powered by low-grade waste heat rather than electricity—massively reducing the enormous electricity consumption of a conventional MVC. Moreover, a MVC generally requires regular maintenance and periodic replacement. An ULTAC, on the other hand, has no major moving parts and requires only minimal maintenance of the requisite pumps and valves. It also do not require a boiler to provide steam source. Hence very robust, very minimum maintenance required.

In addition to the above, the present invention provides further unexpected surprising advantages over conventional crystallisers.

Firstly, a MVC require tremendous amounts of electricity to achieve water vapour compression due to the large difference in vapour enthalpy between the compressor inlet and outlet. In the ULTAC system, for comparison, the difference in enthalpy is achieved by the adsorbent materials constantly adsorbing and desorbing water vapour powered by alternating inputs of hot and cool water. In the ULTAC, electricity is only needed to recirculate the hot and cool water between the AD beds and the respective thermal/cooling sources, and to operate the valves. This obviously requires far less electricity than a MVC.

Secondly, a MVC is also limited by its maximum compression ratio of 2. As a result, a conventional crystallizer are limited to three to four evaporation effects. The lowest brine evaporation temperature must also generally be above 50° C. to evaporate the water from the brine concentrate at normal operating pressures. The same temperature limitations also apply to crystallizers using condensers instead of MVCs. However, the ULTAC system has broken through those limitations, owing to the high affinity of its adsorbent materials to water vapour. The brine evaporation temperature can—in principle—range from 100° C. down to 0° C., with the flexibility to set the crystalliser to operate at any temperature in between. As a result, more evaporation effects can be added to achieve higher energy efficiency.

This means that the ULTAC can achieve evaporation at temperatures below ambient conditions without the need for refrigeration (Significantly reducing energy consumption). At such low temperatures, many salts' solubility decreases significantly—improving yields. The boiling point elevation of the brine is also reduced at lower temperatures. Scaling and fouling on the heat transfer surfaces—and the need for pre-treatment filtration and chemical treatment—is significantly reduced or eliminated. Only minor de-aeration is required in the pre-treatment process.

Whilst there has been described in the foregoing description preferred embodiments of the present invention, it will be understood by those skilled in the technology concerned that many variations or modifications in details of design or construction may be made without departing from the present invention.

1. A crystallization apparatus comprising:
(a) a crystalliser for evaporating a feed water to produce water vapour;
(b) adsorption means in vapour communication with the crystalliser for reversibly adsorbing the water vapour from the crystalliser; and
(c) desorbing means for desorbing the adsorbed water vapour from the adsorption means,
wherein the crystalliser evaporates the feed water at a pressure substantially lower than atmospheric pressure to form a concentrated solution or slurry comprising crystallised solids.

2. The apparatus according to claim 1, wherein the crystalliser evaporates the feed water at a temperature between 0 to 70° C.

3. The apparatus according to claim 2, wherein the crystalliser evaporates the feed water at a temperature below 40° C.

4. The apparatus according to any one of the preceding claims, wherein the crystalliser evaporates the feed water at a pressure of between 0.6 kPa to 32 kPa.

5. The apparatus according any one of the preceding claims, further comprising a boiler for heating the feed water prior to the feed water entering the crystalliser, the heat in the feed water aids the evaporation of the water vapour.

6. The apparatus according to claim 5, wherein the boiler comprises a hot water at a temperature between 5° C. to 85° C.

7. The apparatus according to claim 6, wherein the boiler is a brine heat exchanger.

8. The apparatus according to any one of the preceding claims, further comprising a vacuum pump in vapour communication with the crystalliser for creating a low vacuum state in the crystalliser.

9. The apparatus according to any one of the preceding claims, wherein the adsorption means comprises a plurality of adsorption beds configured to perform adsorption and desorption in a sequential manner to achieve a continuous operation.

10. The apparatus according to claim 9, wherein each bed comprises a finned-tube heat exchanger.

11. The apparatus according to claim 10, wherein each bed comprises an adsorbent material selected from the group comprising: silica gel, synthetic zeolite, silicalite, activated carbon, metal organic frameworks and synthetic alumina.

12. The apparatus according to any one of the preceding claims, wherein the adsorption means comprises a cooling means to provide cooling to aid in the adsorption of the water vapour.

13. The apparatus according to any one of the preceding claims, wherein the desorbing means comprises a heating means to provide heating to aid in the desorption of the adsorbed water vapour.

14. The apparatus according to any one of the preceding claims, further comprising a condenser in vapour communication with the adsorption means.

15. The apparatus according to any one of claims 5 to 14, wherein the condenser tube is in fluid communication with the boiler, the condenser tube is configured to allow heat in the desorbed vapour to be taken up by water in the condenser tube and circulate the heat to the boiler.

16. The apparatus according to any one of the preceding claims, further comprising at least a first a valve between the crystalliser and the adsorption means.

17. The apparatus according to claim 16, further comprising at least a second valve to control a flow of the desorbed water vapour.

18. A method for crystallising a feed water, the method comprising:
(a) crystallising the feed water under a pressure that is substantially lower than atmospheric pressure to form a concentrated solution or slurry comprising crystallised solids, in a crystalliser to produce water vapour;
(b) reversibly adsorbing the water vapour from the crystalliser using an adsorption means in vapour communication with the crystalliser; and
(c) desorbing the adsorbed water vapour from the adsorption means using a desorbing means.

19. The method according to claim 18, comprising crystallising the feed water in the crystalliser at a temperature between 0 to 70° C.

20. The method according to claim 19, comprising crystallising the feed water in the crystalliser at a temperature below 40° C.

21. The method according to any one of claims 18 to 20, comprising crystallising the feed water in the crystalliser at a pressure of between 0.6 kPa to 32 kPa.

22. The method according any one of claims 185 to 21, further comprising heating the feed water prior to evaporation of the feed water in the crystalliser, the heated feed water aids in the adsorption of the water vapour.

23. The method according to claim 22, wherein heating the feed water is carried out in a boiler comprising hot water with a temperature between 5° C. to 85° C.

24. The method according to any one of claims 18 to 23, further comprising evaporating the feed water in a state of low vacuum.

25. The method according to any one of claims 18 to 24, wherein the evaporating and adsorbing steps are performed until a substantial quantity of vapour is adsorbed or saturation of the adsorption means, disengaging the vapour communication between the crystalliser and the adsorption means when the adsorption means is saturated, and desorbing the adsorbed water vapour from the adsorption means until a substantial quantity of the adsorbed water vapour has been desorbed from the adsorption means, and re-establishing the vapour communication between the crystalliser and the adsorption means.

26. The method according to any one of claims 18 to 25, wherein the adsorption means comprises a plurality of adsorption beds configured to perform adsorption and desorption in a sequential manner to achieve a continuous operation.

27. The method according to any one of claims 18 to 26, further comprising providing a cooling means to the adsorption means to aid in the adsorption of the water vapour.

28. The method according to any one of claims 18 to 27, further comprising providing a heating means to the desorbing means to aid in the desorption of the adsorbed water vapour.

29. The method according to any one of claims 18 to 28, wherein desorbing the adsorbed water vapour from the adsorption means comprises circulating hot water proximate to the array of beds, the hot water is at a temperature between 60 to 85° C.

30. The method according to any one of claims 18 to 29, further comprising delivering the water vapour to a condenser for condensing the water vapour.

31. The method according to any one of claims 18 to 30, further comprising the step of de-aerating the feed water prior to the heating and evaporating it.

32. The apparatus and method according to any one of the preceding claims, wherein the feed water is any water selected from the group comprising: brackish, sea, produce, reverse osmosis rejects, waste, and salt.
